(19) United States
(12) Patent Application Publication
(10) Pub. No.: US 2022/0243648 A1
(43) Pub. Date: Aug. 4, 2022

(54) Erez Engine - An Internal Combustion Rotary Engine

(71) Applicant: SMARTIVE TECH LTD., Moshav Merchavia (IL)

(72) Inventor: Erez YIFLACH, Moshav Merchavia (IL)

(21) Appl. No.: 17/617,742

(22) PCT Filed: Jun. 7, 2020
(86) PCT No.: PCT/IL2020/050635

§ 371 Date: Dec. 9, 2021

Related U.S. Application Data
(60) Provisional application No. 62/859,121, filed on Jun. 9, 2019.

(51) Int. Cl. F02B 53/02; F01C 21/18; F01C 21/08

(52) U.S. Cl. CPC F02B 53/02; F01C 1/3566; F01C 21/08; F01C 21/18

(57) ABSTRACT

An internal combustion rotary engine comprises: at least one combustion chamber; a flywheel; at least one piston provided in said flywheel; two or more barrier elements; a circumferential volume between the outer surface of said flywheel, the housing of said flywheel, and two or more barrier elements; wherein some parts of the circumferential volume are also delimited by one or more pistons, and wherein the barrier elements are adapted to be positioned within said circumferential volume thereby to essentially block the flow of air therein, and to be positioned such as to at least partially unblock the flow of air therein, thereby allowing said air flow to take place, and to be positioned such as to be totally open to promote the piston to move between circumferential area and wherein the timing of movement of the barrier elements is dependent from the rotation of said flywheel and/or the location of said piston(s); and wherein the barrier element that is in contact with a portion of pressurized air is adapted to move without the need for sealing while the piston is blocking the pressurized air that is needed for combustion inside the combustion chamber, wherein the piston partitions the pressurized air into two portions, one of which is locked in the combustion chamber while the other is located between the front of the piston and the barrier element.

### FIELD OF THE INVENTION

The present invention is in the field of internal combustion engines. More specifically, the invention relates to the field of internal combustion rotary engines.

### BACKGROUND OF THE INVENTION

Internal combustion rotary engines were first invented decades ago, and are well known for providing a relatively high efficiency in comparison to non-rotary engines, due to the fact that the rotary mechanism less suffers from energy losses during motion, for example, the energy losses that are common in internal combustion engines during the motion conversion from a liner motion into a rotational motion.

According to the prior art, internal combustion rotary engines usually comprise complex mechanisms that often have multiple moving components, which involve contact of said components that cause grinding of the components and shortens the lifetime of the engines, and of course, also increases the need for maintenance and reduces the efficiency of the engines due to energy losses caused by friction. Such engines also suffer from sealing problems with the compressed air/mixture, and they use a contact between different components for sealing. The separators/doors/barrier elements usually follow by contact the shape of the flywheel and the piston(s) in order to prevent air/mixture from escaping their designated volumes during the operation of the engines.

Furthermore, many of the existing rotary engines suffer from significant sealing problems, leading to reduced efficiency caused by fluid leakage between adjacent stroke chambers and to increased oil consumption, being continuously consumed for sealing between adjacent chambers, and for lubricating of movable mechanisms.

It is therefore an object of the present invention to provide an internal combustion rotary engine, which comprise central rotating components that do not come in any contact with other components of the engines, apart from the components that are responsible for their movement.

According to one embodiment of the invention, the invention comprises one or more micro spaces between moving components for sealing. In addition, the present invention comprises one or more ignition chambers that are suitable to provide a combustion volume that in some parts of the circumferential volume of the rotary engine, combines with said circumferential volume, and by piston(s) we separate and lock the compressed air/mixture in the combustion volume(s), thus allow to move the barrier elements without contact with the flywheel and/or the piston(s) of the engine. Yet, there is a mechanical connection between the flywheel and the barrier elements with regards to the timing of their operation, depending on the timing protocol of the components of the engine, without a direct dependency on the movement of the flywheel and/or piston(s). By providing the securing of compressed air/mixture in the combustion volume, the timing of the ignition is more controllable and can be set to the right moment and no contact in required to keep the sealing. The phrase “circumferential volume” will be explained in detail as the description proceeds, along the detailed description.

It is another object of the present invention to provide an internal combustion rotary engine that comprises a geometry and components that improve the sealing between the different components of the engine compared to other rotary engines known in the prior art, thereby improve the efficiency of the engine.

It is yet another object of the invention to provide an internal rotary combustion engine that provides an improved exhaust cleaning operation and a method thereof.

Other objects and advantages of the invention will become apparent as the description proceeds.

### SUMMARY OF THE INVENTION

An internal combustion rotary engine, comprises:

at least one combustion chamber;
a flywheel;
at least one piston provided in said flywheel;
two or more barrier elements;
a circumferential volume between the outer surface of said flywheel, the housing of said flywheel, and two or more barrier elements;

wherein some parts of the circumferential volume are also delimited by one or more pistons, and wherein the barrier elements are adapted to be positioned within said circumferential volume thereby to essentially block the flow of air therein, and to be positioned such as to at least partially unblock the flow of air therein, thereby allowing said air flow to take place, and to be positioned such as to be totally open to promote the piston to move between circumferential area and wherein the timing of movement of the barrier elements is dependent from the rotation of said flywheel and/or the location of said piston(s);

and wherein the barrier element that is in contact with a portion of pressurized air is adapted to move without the need for sealing while the piston is blocking the pressurized air that is needed for combustion inside the combustion chamber, wherein the piston partitions the pressurized air into two portions, one of which is locked in the combustion chamber while the other is located between the front of the piston and the barrier element.

In one embodiment, a portion of the compressed air that is located in the front of the piston is used for discharging the combustion gases that are left from the previous operation, when the barrier element is in an at least partially unblocking position. In another embodiment, the engine is adapted to compress mixture instead of air.

In some embodiments, the engine is adapted to contain a mixture, while the barrier element is in closed position, and suitable to allow the portion of pressurized mixture, in the front of the piston, to flow through the entrance and into the intake system.

In some embodiments, the piston is integral with the flywheel, and in others, it is separate from the flywheel.

The engine barrier elements can be linearly movable or rotationally movable.

In one embodiment, the engine comprises a port adapted to contain pressurized gas suitable to aid the discharge of combustion gas. In another embodiment, the port is provided in the flywheel. In a further embodiment, the engine comprises a port adapted to enable the entry of air/mixture into the circumferential volume of the engine, and in yet another embodiment the port is provided in the flywheel.

The engine may further comprise micro spaces between two or more parts of the engine for sealing without contact. In one embodiment the engine can optionally comprising a groove, suitable to induce a turbulent flow to increase the sealing.

In one embodiment, the engine can optionally comprise a “Geneva Gear” mechanisms, suitable to control the timing of the movement of the barrier elements.

In one embodiment the engine further comprises rotating barrier elements, wherein the engine components are centered relative to the axle and rotate around the axle.

### BRIEF DESCRIPTION OF THE DRAWINGS

FIG. 1 is a front perspective view of the engine, according to one embodiment of the invention;

FIG. 2 is a rear perspective view of the engine of FIG. 1;

FIG. 3 schematically illustrates the engine of FIG. 1, simultaneously starting intake and compression strokes;

FIG. 4 is a front view of the engine of FIG. 1, demonstrating the intake and compression strokes;

FIG. 5A shows an engine, according to another embodiment of the invention, further comprises an air-trapping groove;

FIG. 5B is an enlarged view of section A of FIG. 5A;

FIG. 6A is a front view of the engine of FIG. 1, wherein the engine is at the very end of the intake and compression strokes;

FIG. 6B is an enlarged view of section B of FIG. 6A, in which a portion of compressed gas is located past the combustion chamber;

FIG. 7 schematically illustrates the engine of FIG. 1 during ignition;

FIG. 8A shows the engine of FIG. 7 after the ignition, with a slight clockwise rotation of the top left barrier element;

FIG. 8B is an enlarged view of section C of FIG. 8A, illustrating that the compressed air can flow toward the exhaust gas;

FIG. 9 shows that after the flywheel starts to rotate as a result of the ignition, while barrier element is simultaneously positioned to align with the round circumference of the top left cavity, the new exhaust gas can flow through the expending volume defined by the top right and left barrier elements, the combustion chamber, the flywheel and its piston, which expends the volume that contains the new exhaust gas while rotating;

FIG. 10 is a front view of the engine, according to another embodiment of the invention, in which the engine comprises an engine block, a flywheel that comprises two pistons, eight barrier elements, and four combustion chambers;

FIG. 11A is another embodiment of the present invention, showing a perspective view of another engine, which resembles the engine of FIG. 10, other than the fact that the exhaust and intake ports are located in the flywheel;

FIG. 11B is an enlarged view of section D of FIG. 11A, illustrating the flow of gas through the ports that are located in the flywheel; and

FIG. 12 is a front view of the engine, according to another embodiment of the invention, wherein the barrier elements are linear barrier elements.

### DETAILED DESCRIPTION OF THE INVENTION

The present invention relates to an internal combustion rotary engine, which can also be referred to simply as “Erez engine” or just “engine” along the description, for the sake of brevity. The phrase “Erez engine” refers to its commercial name and does not indicate its structure. The engine, according to the invention, comprises a flywheel, a flywheel-housing, one or more pistons, one or more combustion chambers, ignition/injector elements, exhaust port(s), and intake port(s), and one or more barrier elements, suitable to block or allow the flow of gases.

Another phrase that will be used along the description is the “circumferential volume” of the engine, which describes the volume defined between the housing of a flywheel, the outer surface of said flywheel, one or more barrier elements, and in some parts of the circumferential volume also by one or more pistons.

In the following detailed description, references are made to the accompanying drawings, which illustrate specific embodiments or examples, according to the invention. These embodiments may be combined, other embodiments may be utilized, and other changes may be made without departing from the spirit or scope of the present invention.

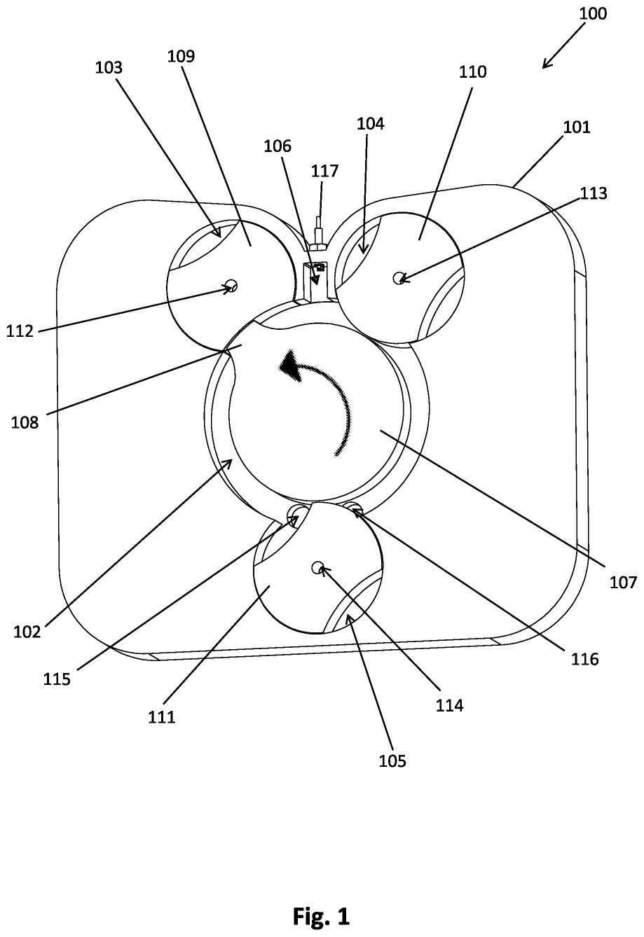

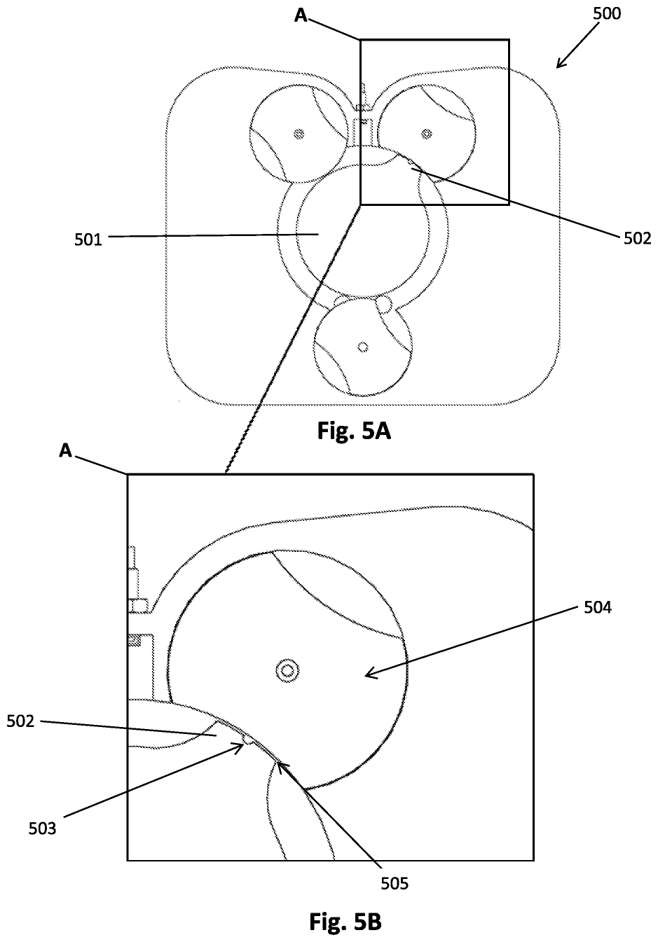

FIG. 1 is a front perspective view of Erez engine 100, according to one embodiment of the present invention, which comprises an engine block 101. Engine block 101 comprises cavities 102, 103, 104 and 105, a combustion chamber 106, a flywheel 107, and a piston 108. Flywheel 107 is located inside cavity 102, which is also referred to as “flywheel-housing”. Flywheel 107 comprises piston 108 that has a maximal diameter essentially the size of the diameter of cavity 102, and it can also be only almost the same size, in order to leave a very small void between the outer surface of cavity 102 and piston 108, thus reducing friction between said parts, as will be shown in FIG. 5B. According to this embodiment, piston 108 is integral with flywheel 107, but each of them has a different role, as can be easily understood by their names and descriptions, thus are referred to as separate parts. According to other embodiments of the invention, the piston and the flywheel can be different parts that are attached to one another.

Erez engine 100 further comprises barrier elements 109, 110 and 111, respectively positioned inside cavities 103, 104 and 105, suitable to rotate inside them. While there is no permanent separation between cavities 103-105 and cavity 102, they are referred to as individual cavities, since barrier elements 109-111 can, at certain positions, create a separation between them, or allow flow of gasses from one cavity into another.

Each of barrier elements 109-111 can be actuated through a shaft (not shown), suitable to be located inside shaft holes, respectively indicated by numerals 112, 113 and 114, in order to rotate within corresponding cavities 103-105.

As further shown in FIG. 1, engine block 101 also comprises exhaust port 115, suitable to allow the evacuation of combustion gases, and intake port 116, suitable to allow the flow of gasses into the circumferential volume of Erez engine 100.

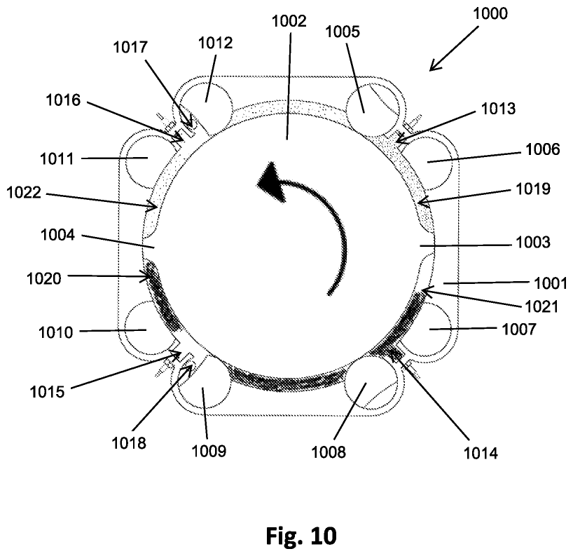

Although according to the present embodiment ports 115 and 116 are not fully blocked while not in use, it is possible to used alternative configurations that will provide the blockage of said ports when the flow through them is not necessary, as demonstrated in the following figures that show other embodiments of the invention, for example, in FIG. 10.

Ignition of compressed gas takes place inside combustion chamber 106. If an external spark is necessary, it can be provided by a spark-plug 117, which may be controlled, for example, by electronic or electromechanical means. Combustion chamber is also suitable to be injection with fuel, such as diesel, into chamber 106 while it contains compressed air. Although a fuel injection element is not shown in FIG. 1, suitable devices are well known in the art, and can be easily integrated with Erez engine 100 by a person skilled in the art.

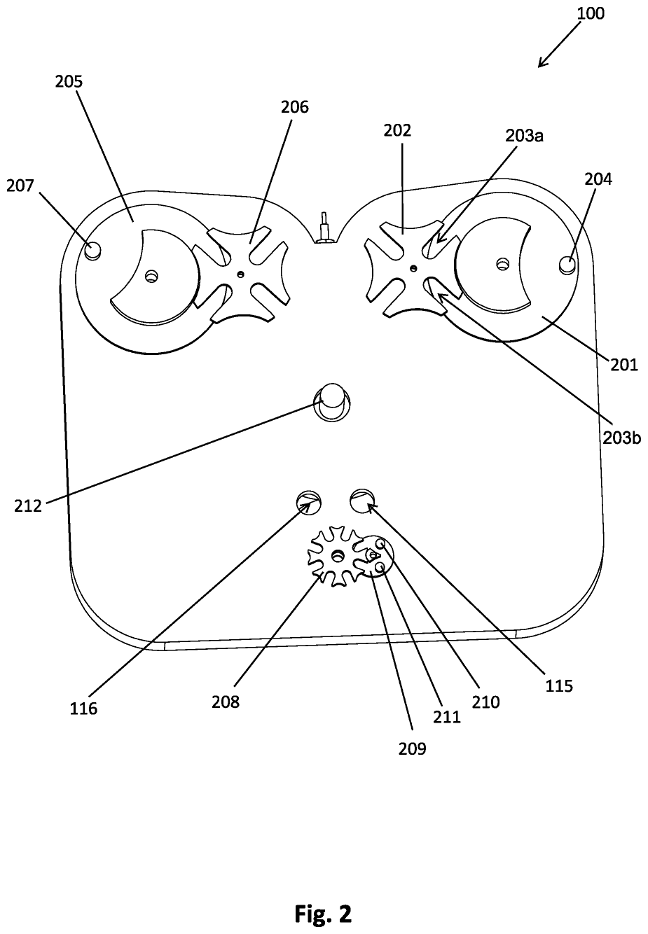

FIG. 2 is a rear perspective view of engine 100 of FIG. 1, showing Geneva drive mechanisms (a mechanism well known in the art, also known as “Geneva gear”), suitable to control the rotations of barrier elements 109-111. The top right Geneva gear in FIG. 2, which controls the rotation of barrier element 109 of FIG. 1, comprises a driving wheel 201 and a driven wheel 202, which has four slots, such as slots 203a and 203b, arranged in 90 degrees intervals, thus element 109, which is connected to wheel 202, is set to rotate in steps of 90 degrees. Driving wheel 201 comprises pin 204, and when wheel 201 rotates, for example, clockwise, it enters slot 203b, causing driven wheel 202 to rotate counter-clockwise, repositioning slot 203b in the previous position of slot 203a.

In a similar manner, driving wheel 205 of the top left Geneva gear rotates driven wheel 206, which is connected to barrier element 110 of FIG. 1, by pin 207. Driven wheel 208 that belongs to the bottom Geneva gear, is controlled by the rotation of driving wheel 209 and it comprises eight slots, thus barrier element 111 of FIG. 1 is set to rotate in steps of 45 degrees. Driving wheel 209 comprises two pins 210 and 211, thus providing two rotations of 45 degrees of wheel 208 for every full rotation of wheel 209. The timing of the movement of each driven wheel 202, 206 and 208 is controlled by the angular velocity of driving wheels 201, 205 and 209, which are controlled by a mechanical connection to the flywheel shaft 212 which is connected to flywheel 107 of FIG. 1 (connection such as a timing belt). Such external means can be, for example electronic or electromechanical means, such as independent electric motors that are coupled with timing belts to driving wheels 201, 205 and 209.

Although it is obvious to any person skilled in the art, it is noted that the Geneva mechanisms of FIG. 2 can be modified in order to obtain different operational parameters, for example, the rotation angle of elements 109-111 of FIG. 1 is controlled by the number of slots, and the pace of driven wheels 202, 206 and 208 is controlled by the angular velocity of driving wheels 201, 205 and 209, and by the number of pins, such as pins 204, 207, 210 and 211. Each parameter can be modified in order to provide a desired movement of barrier elements 109-111. It should also be noted that the Geneva mechanisms of FIG. 2 can be replaced by any other mechanisms, suitable to control the movement of barrier elements 109-111.

FIG. 2 also shows an exhaust port 115 and intake port 116 of FIG. 1. Ports 115 and 116 can be provided with valves, suitable to allow the flow of gas through them only under a certain pressure or at a predetermined timing. Ports 115 and 116 can also be further connected to pipes or other gas delivery elements.

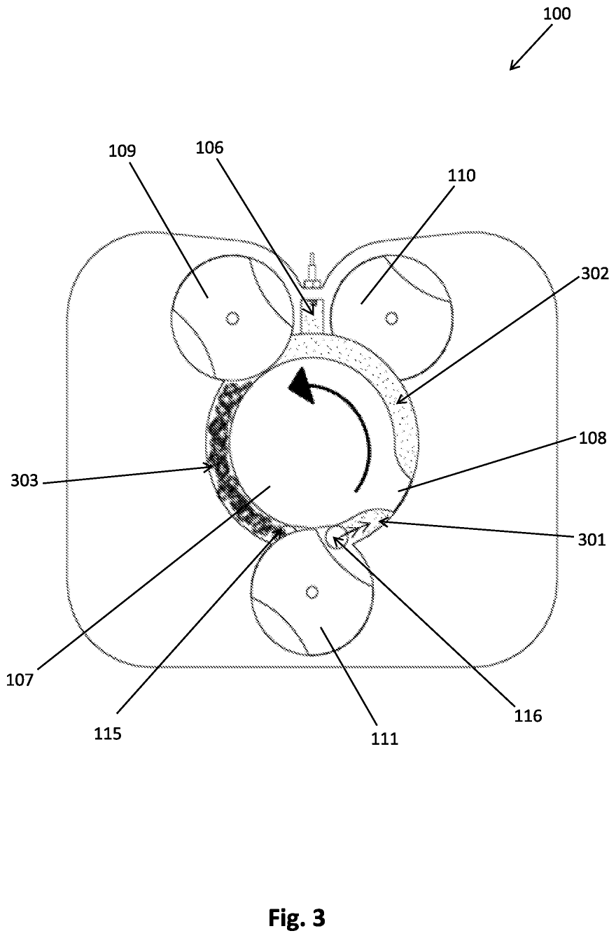

FIG. 3 schematically illustrates Erez engine 100 of FIG. 1, simultaneously starting an intake stroke in volume 301, and a compression stroke in volume 302, wherein volume 301 of the intake increases between barrier element 111 and piston 108, as piston 108 rotates counter clockwise, while volume 302 of the compression decreases between piston 108 and barrier element 109. At this state, element 111 is at a position that fully exposes intake port 116, allowing the flow of gas through port 116 and into volume 301. Element 110 is at a position that allows the flow of gas and defines volume 302, which also includes combustion chamber 106, and element 109 is at a position that blocks the flow of gas, thus separating volumes 302 from volume 303, which consists the exhaust gas from a previous cycle.

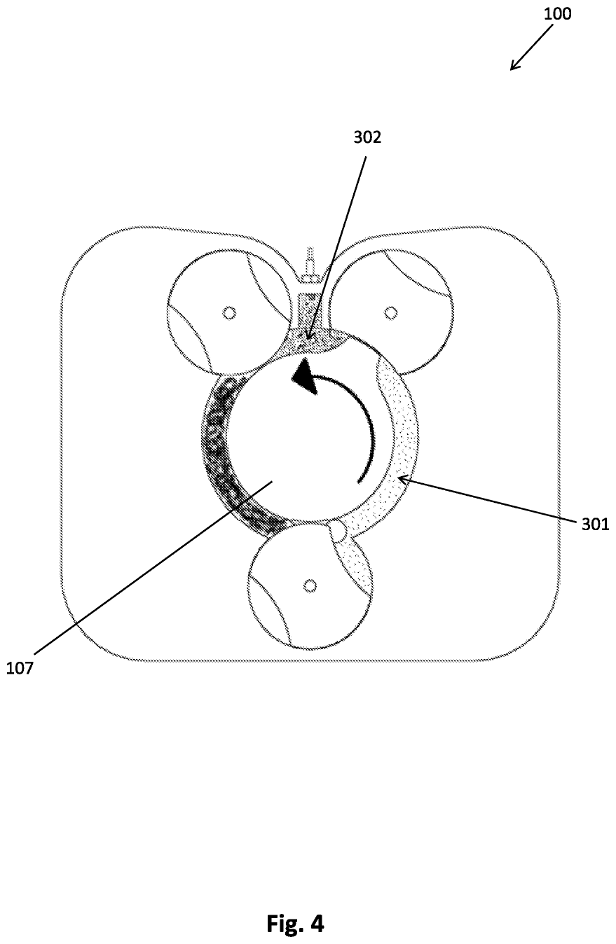

FIG. 4 is a front view of the engine of FIG. 1, demonstrating the intake and compression strokes after a slight counter-clockwise rotation of flywheel 107 in comparison to its position in FIG. 3. As a result, volume 301 increases and volume 302 decreases simultaneously, thus compressing the gas inside volume 302.

According to another embodiment of the invention, FIG. 5A shows another Erez engine 500, which comprises a flywheel 501 and a piston 502. FIG. 5B is an enlarged view of section A of FIG. 5A, showing a micro space 503 between piston 502 and barrier element 504, which provides sealing during the engine operation. Such micro-space that are used for sealing can be provided between some or all of the moving components of the engine. FIGS. 5A and 5B show air-trapping groove 503, which increase the sealing between piston 502 and barrier element 504 by providing a turbulent sealing, wherein the trapped gas between groove 503 and barrier element 504 that is located in gap 505, also flows in a vortex flow due to groove 503. Such turbulent sealing mechanism can also be provided between other parts of the engine in order to improve the sealing. Even without groove 503, gap 505 provides a micro space between piston 502 and barrier element 504, which seal the air/mixture, and as a result, decreases energy loses in the engine.

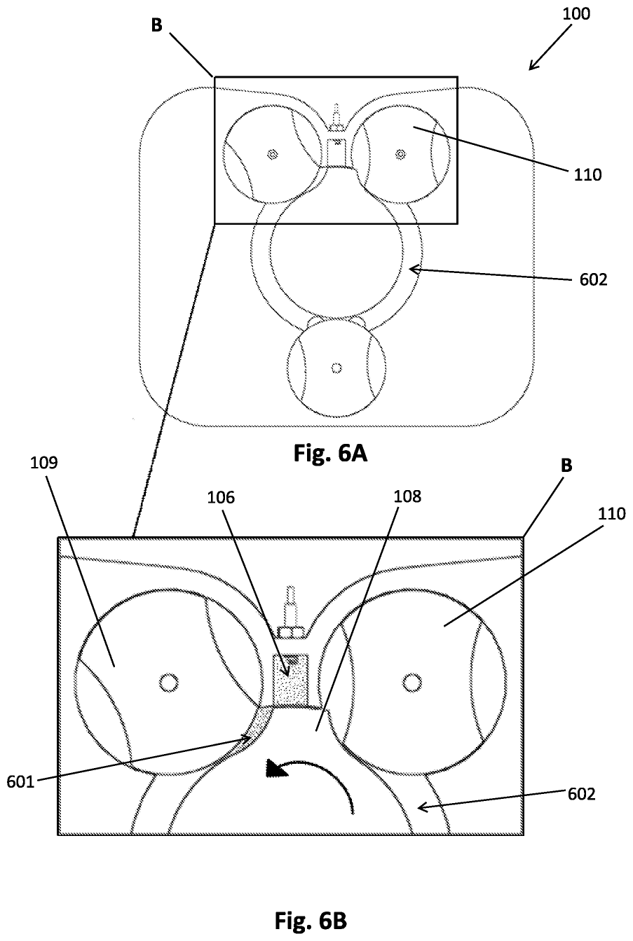

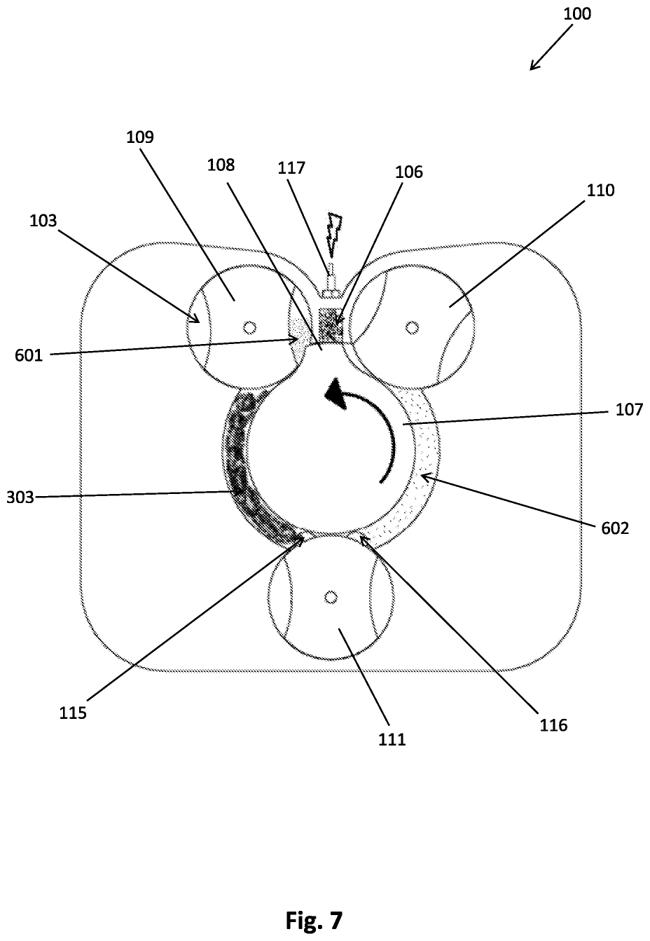

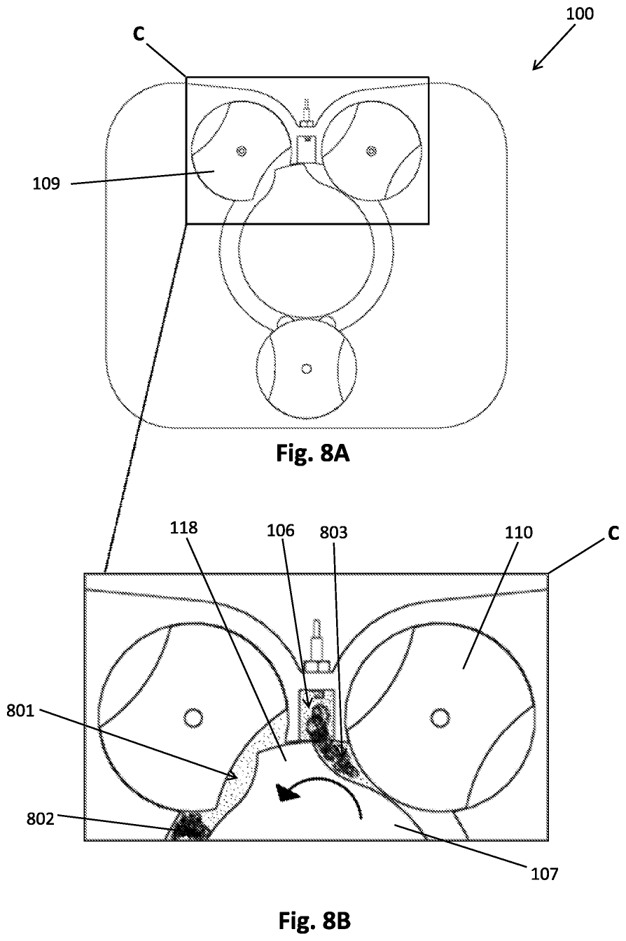

FIG. 6A is a front view of Erez engine 100 of FIG. 1, wherein Erez engine 100 is at the very end of the intake and compression strokes. FIG. 6B is an enlarged view of section B of FIG. 6A, which shows the moment that piston 108 separates the compressed air/mixture into two different volumes 601 and 106, in which a portion 601 of compressed gas (such as a mixture or air) is located past the combustion chamber 106, which mean that all the gas that was compressed and shown in volume 302 in FIG. 4 is divided into two separate volumes 601 and 106. It should be noted that the location, geometry and position of barrier element 109 during compression provides the flow of gas past chamber 106 during the compression stroke, thus providing portion 601 of compressed gas past chamber 106, in addition to the compressed gas in chamber 106, which after the compression stroke is blocked by piston 108 and kept inside chamber 106 and waiting for the right timing for ignition, which provides the opportunity to move the barrier elements without any need of contact between the barrier elements and the flywheel and piston(s). Portion 601 of compressed air is exploited for enhancing the flushing of combustion gases as will be described in further details hereinafter with respect to FIGS. 7 and 8B. As further shown in FIGS. 6A and 6B, barrier element 110 is at a position that blocks the passage of gas from volume 602.

A significant advantage of the invention over the prior art is the fact that the barrier element that is in contact with a portion of pressurized air is adapted to move without the need for sealing while the piston is blocking the pressurized air that is needed for combustion inside the combustion chamber. The barrier elements are controlled by a mechanical connection, such as a “Geneva Gear”, and their movement is controlled by a relation with the flywheel and/or piston(s), but without direct connection or cam function. In addition to the great advantage of improving the efficiency of the engine by avoiding friction between the barrier elements and the flywheel and piston(s), this fact also provides a combustion timing that is not dependent or limited by the operation of the barrier elements, but only on the location of the piston in relation to the combustion chamber, which occurs when the compressed gas is in the combustion chamber and blocked by the piston.

Along the description references are made to “gas”, and it should be noted that the phrase refers to any type of gas that are suitable to be used in internal combustion engines, such as air or a mixture of fuel with gas. Such gas can also be in a compressed state. The “gas” can also be replaced with other forms of fluids, suitable to be used in internal combustion engines.

FIG. 7 schematically illustrates Erez engine 100 of FIG. 1 during ignition, in which plug 117 produces a spark within combustion chamber 106, thus igniting the contained compressed gas, while element 109 is in a positioning that allows portion 601 to be located between the surface of cavity 103, the surface of element 109, and piston 108. Also shown in FIG. 7 is volume 602, consisting gas that entered the engine through intake port 116, which is restricted by flywheel 107 and barrier elements 110 and 111, and volume 303, consisting exhaust gas, which flows out of the engine through exhaust port 115. The timing of the ignition is important and should occur when flywheel 107 is at a position that permits the flow of exhaust gas from chamber 106 and into the volume that is restricted by flywheel 107, piston 108, and element 110, as shown in FIG. 8B.

FIG. 8A shows Erez engine 100 after the ignition that was illustrated in FIG. 7, with a slight clockwise rotation of barrier element 109 and a slight counter-clockwise rotation of flywheel 107. FIG. 8B is an enlarged view of section C of FIG. 8A, illustrating that at this specific position of element 109 and flywheel 107, provided after the ignition, the compressed gas 801 that was located in portion 601, as shown in FIGS. 6B and 7, can flow toward the exhaust gas 802. The incorporation of compressed gas with exhaust gas provides a significant advantage to the exhaustion stage, since the high pressure of compressed gas 801 “pushes” exhaust gas 802 and provides a very efficient cleaning operation of Erez engine 100, which provides clear advantages over the prior art.

The compressed gas that passes the combustion chamber can also be redirected and reused in another compression stroke. It can be beneficial when, for example, the compressed gas is a mixture that can be utilized for combustion. According to other embodiment of the invention, the engine further comprises a flow path, suitable to allow this portion of pressurized gas to flow and merge with gases adapted to flow into the circumferential volume through an intake port. According to another embodiment of the invention, the engine further comprises suction means suitable to lead the portion of pressurized gas into the flow path.

As shown in FIG. 7, at the moment before the ignition, and after the combustion, as shown in FIG. 8B, flywheel 107 is pushed, and due to the positioning of piston 108 prior to the combustion and to the shape of piston 108 in relation the shape of flywheel 107, flywheel 107 is pushed in the desired direction. The timing of the ignition is important and should occur when the positioning of piston 108 provides the counter-clockwise pushed of flywheel 107 as a result of the expansion of gases and the geometry of flywheel 107 and piston 108, and when the positioning of piston 108 permits the flow of exhaust gas from chamber 106 and into the volume that is restricted by flywheel 107, piston 108 and element 110.

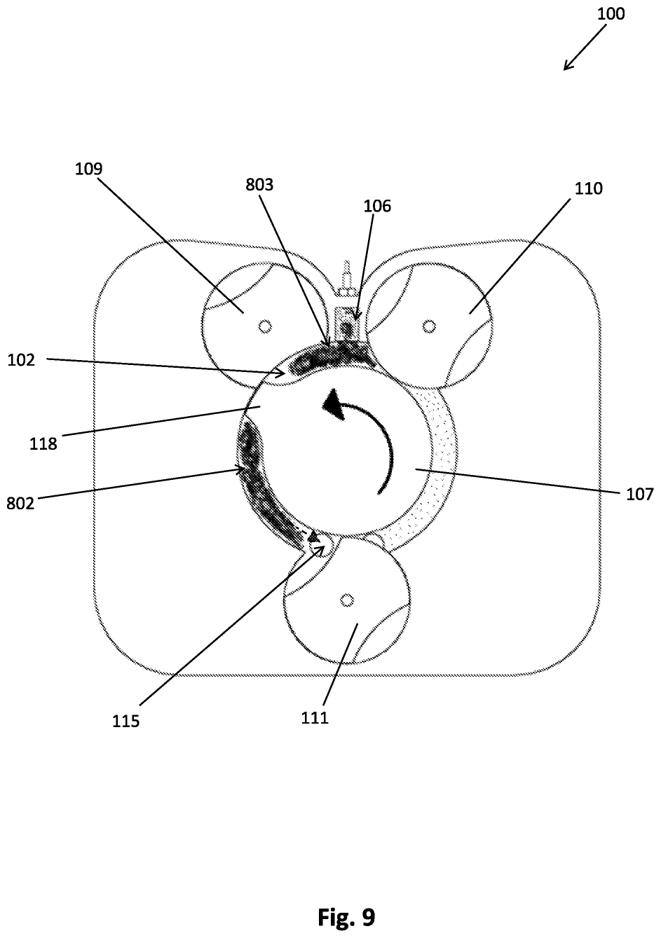

After the ignition, the new exhaust gas 803, which is created as a result of the ignition, flows to the right and is restricted by flywheel 107, piston 108, barrier element 110, and chamber 106. FIG. 9 shows that after flywheel 107 starts to rotate counter-clockwise as a result of the ignition, while barrier element 109 is simultaneously positioned to align with the round circumference of cavity 102, the new exhaust gas can flow through the expending volume that is defined by barrier elements 109 and 110, combustion chamber 106, flywheel 107, and piston 108, which expends the volume that contains the new exhaust gas 803 while rotating. At this state, barrier element 111 slightly rotates clock-wise in order to expose exhaust port 115 and allow exhaust gas 802 from the previous cycle to leave Erez engine 100 through port 115.

Flywheel 107 of FIGS. 1-9 comprises a single piston 108, but the flywheel, according to other embodiments of the invention, can also comprise two or more pistons, such as piston 108, thus enabling number of simultaneous cycles of the same type, thus can also be in a different shapes and sizes. Barrier elements 109-111 can also be replaced by other elements of different shapes and sizes, suitable to restrict or allow the flow of fluids. It should also be noted that the engine, according to the present invention, can also comprise additional combustion chambers, and the location of said chambers can be modified, in order to allow other compression/pressure/volume relations between the different gasses in the engine. Of course, additional exhaust and intake ports can be provided given additional ignition chambers, and their location can also be modified as another mean for controlling the compression/pressure/volume relations between the gasses in the engine.

FIG. 10 is a front view of the Erez engine, according to another embodiment of the invention, in which Erez engine 1000 comprises an engine block 1001, rotary flywheel 1002 that comprises two pistons 1003 and 1004, eight barrier elements 1005-1012, and four combustion chambers 1013-1016. Erez engine 1000 also comprises intake and exhaust pots, such as intake port 1017 and exhaust port 1018. It should be noted that the engine comprises intake and exhaust ports behind every barrier element 1005-1012, such as ports 1017 and 1018. The other ports are not shown in this figure since they are located behind barrier elements 1005-1012, which block said ports in the specific positioning that is shown in FIG. 10. When the movement of flywheel is counter-clockwise, the first port is an intake port, and the second is an exhaust port.

In the positioning shown in FIG. 10, piston 1003 (compress-power piston) is responsible for the compression stroke of volume 1019 and the power stroke of volume 1021, while piston 1004 (intake-exhaust piston) is responsible at the same time for the exhaust stroke of volume 1020 through exhaust port 1018 and the intake stroke of volume 1022 through port 1017. According to this embodiment, one piston is always responsible for the compression and combustion strokes, while the other is responsible for the exhaust and intake strokes.

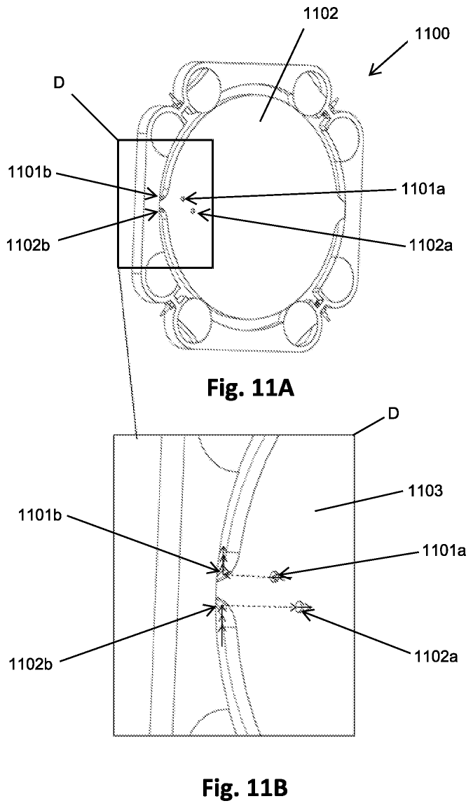

FIG. 11A is another embodiment of the present invention, showing a perspective view of another Erez engine 1100, which resembles engine 1000 of FIG. 10, other than the fact that the intake and exhaust ports, which are respectively indicated by numerals 1101a-b and 1102a-b, are located in flywheel 1103. FIG. 11B is an enlarged view of section D of FIG. 11A, showing that intake gasses can enter flywheel 1103 through port 1101a and then the inner volume of the engine through port 1101b, and exhaust gasses can enter flywheel 1103 through port 1102b and then leave the engine through port 1102a.

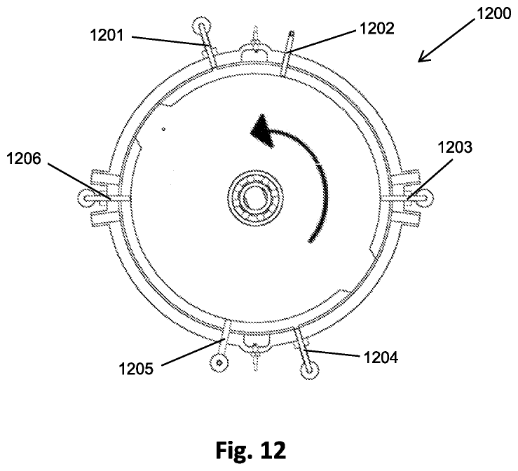

FIG. 12 is a front view of Erez engine 1200, according to another embodiment of the present invention, wherein one difference between engine 1200 and engine 100 of FIG. 1 is the fact that the barrier elements of FIG. 1 (which also resemble the other barrier elements in the embodiments of FIGS. 2-11B) can be replaced with linear barrier elements, such as elements 1201-1206. Another difference between engine 100 and engine 1200 is the number of combustion chambers. Such linear barrier elements are suitable to move up and down in order to allow or block fluids from passing through the circumferential volume. Of course, there are other structures that can also replace the barrier element that are presented in the drawings, as can be easily concluded by a person skilled on the art, and the invention is not limited to any specific shape or type of barrier elements.

Although the invention is not limited to a specific shape of barrier elements, it should be noted that barrier elements of FIGS. 1-11B provide a significant advantage over the prior art, due to the fact that their shape allows them to endure relatively high loads and provides a rotational movement, and as a result the barrier elements are less subjected to wear and tear.

Although embodiments of the invention have been described by way of illustration, it will be understood that the invention may be carried out with many variations, modifications, and adaptations, without exceeding the scope of the claims.

1. An internal combustion rotary engine, comprising:
at least one combustion chamber;
a flywheel;
at least one piston provided in said flywheel;
two or more barrier elements;
a circumferential volume between the outer surface of said flywheel, the housing of said flywheel, and two or more barrier elements;
wherein some parts of the circumferential volume are also delimited by one or more pistons, and wherein the barrier elements are adapted to be positioned within said circumferential volume thereby to essentially block the flow of air therein, and to be positioned such as to at least partially unblock the flow of air therein, thereby allowing said air flow to take place, and to be positioned such as to be totally open to promote the piston to move between circumferential area and wherein the timing of movement of the barrier elements is dependent from the rotation of said flywheel and/or the location of said piston(s);
and wherein the barrier element that is in contact with a portion of pressurized air is adapted to move without the need for sealing while the piston is blocking the pressurized air that is needed for combustion inside the combustion chamber, wherein the piston partitions the pressurized air into two portions, one of which is locked in the combustion chamber while the other is located between the front of the piston and the barrier element.

2. An engine, according to claim 1, wherein a portion of the compressed air that is located in the front of the piston is used for discharging the combustion gases that are left from the previous operation, when the barrier element is in an at least partially unblocking position.

3. An engine, according to claim 1, adapted to compress flammable materials or mixture instead of air.

4. An engine according to claim 3, adapted to contain a mixture, while the barrier element is in closed position, and suitable to allow the portion of pressurized mixture, in the front of the piston, to flow through the entrance and into the intake system.

5. An engine, according to claim 1, wherein the piston is integral with the flywheel, or separate from the flywheel.

6. An engine according to claim 1, wherein the barrier elements are linearly movable.

7. An engine according to claim 1, wherein the barrier elements are rotationally movable.

8. An engine according to claim 1, comprising a port adapted to contain pressurized gas suitable to aid the discharge of combustion gas.

9. An engine according to claim 8, wherein the port is provided in the flywheel.

10. An engine according to claim 1, comprising a port adapted to enable the entry of air/mixture into the circumferential volume of the engine.

11. An engine according to claim 10, wherein the port is provided in the flywheel.

12. An engine according to claim 1, further comprising micro spaces between two or more parts of the engine for sealing without contact.

13. An engine according to claim 1, further optionally comprising a groove, suitable to induce a turbulent flow to increase the sealing.

14. An engine according to claim 1, further optionally comprising a “Geneva Gear” mechanisms, suitable to control the timing of the movement of the barrier elements.

15. An engine according to claim 1, further comprising rotating barrier elements, wherein the engine components are centered relative to the axle and rotate around axle.

16. An engine according to claim 15, further comprising micro spaces between the center components for sealing.
